(19) United States
(12) Patent Application Publication
(10) Pub. No.: US 2026/0066627 A1
(43) Pub. Date: Mar. 5, 2026

(54) Device For Confirming A Bolt Pattern Of A Current Transformer Cabinet

(71) Applicant: Commonwelth Edison Company, Chicago, IL (US)

(72) Inventors: Bradley Preston, Chicago, IL (US); Nicholas DePinto, Chicago, IL (US); Kyle Hays, Chicago, IL (US)

(21) Appl. No.: 18/824,287

(22) Filed: Sep. 4, 2024

(51) Int. Cl. H02B 3/00; H02B 1/32

(52) U.S. Cl. CPC H02B 3/00; H02B 1/32

(57) ABSTRACT

A template device having a plate and a pattern of openings defined within the plate. The plate has a first section, a second section, a third section, and first and second ends oppositely disposed. The first section includes the first end, the second section includes the second end, and the third section is positioned between the first and second sections. The pattern of openings corresponds to positioning of bolt holes within a bar of a bar-type current transformer assembly. The pattern of openings includes: a first plurality of openings positioned in the first section and configured to overlie holes defined within a first portion of the bar of the current transformer assembly; and a second plurality of openings positioned in the second section and configured to overlie holes defined within a second portion of the bar of the current transformer assembly.

### FIELD

This invention concerns a device for determining whether a current transformer assembly has holes that correspond to a bolt pattern in a current transformer cabinet.

### BACKGROUND

FIG. 1 shows an example current transformer cabinet 2 with an example current transformer assembly 4. When current transformer cabinets are installed, like the current transformer cabinet 2 shown in FIG. 1, technicians are required to ensure the current transformer assemblies meant to be mounted in the current transformer cabinets, like the current transformer assembly 4 shown in FIG. 1, can be mounted to the fixed bolts inside the cabinet. More specifically, technicians determine whether the pre-drilled bolt holes 6 in the current transform assembly 4 properly align with the fixed bolts 8 inside the cabinet 2. If the technician determines the pre-drilled bolt holes 6 do not align with the fixed bolts 8 inside the cabinet 2, the electrician will need to adjust the fixed bolts 8. To check the alignment of the fixed bolts, technicians are required to carry the current transformers, which typically come in a box of three, wherein each current transformer assembly weighs about 6.5 pounds, to the new current transformer cabinet.

Technicians also have to carry a clipboard and tool pouch while ensuring one hand is free to safely apply three points of contact if necessary. There is clearly a need for a template device that can be used to check the bolt pattern of the fixed bolts inside a current transformer cabinet that weighs less and is easier to carry than current transformers.

### SUMMARY

An example template device according to the disclosure comprises a plate having a first section, a second section, a third section, and first and second ends oppositely disposed. The first section includes the first end. The second section includes the second end. The third section is positioned between the first and second sections. A pattern of openings that corresponds to positioning of bolt holes within a bar of a bar-type current transformer assembly. The pattern of openings comprises a first plurality of openings positioned in the first section and configured to overlie holes defined within a first portion of the bar of the current transformer assembly. The pattern of openings comprises a second plurality of openings positioned in the second section and configured to overlie holes defined within a second portion of the bar of the current transformer assembly.

In an example embodiment, the plate consists of a non-metallic material.

In an example embodiment, the plate consists of a non-conductive material.

In an example embodiment, the plate consists of a plastic material.

In an example embodiment, the plate extends along a longitudinal axis.

In a further example embodiment, the first plurality of openings comprises a first opening and a second opening.

In a further example embodiment, the second opening of the first plurality of openings is positioned between the first opening of the first plurality of openings and the third section.

In a further example embodiment, the first opening of the first plurality of openings is circular.

In a further example embodiment, the second opening of the first plurality of openings is elongated.

In a further example embodiment, the first opening of the first plurality of openings and the second opening of the first plurality of openings are aligned along the longitudinal axis.

In a further example embodiment, the second plurality of openings comprises a first opening and a second opening.

In a further example embodiment, the second opening of the second plurality of openings is positioned between the first opening of the second plurality of openings and the third section.

In a further example embodiment, the first opening of the second plurality of openings is circular.

In a further example embodiment, the second opening of the second plurality of openings is elongated.

In a further example embodiment, the first opening of the second plurality of openings and the second opening of the second plurality of openings are aligned along the longitudinal axis.

In a further example embodiment, the pattern of openings further comprises a center opening positioned in the third section. The center opening is configured to overlie a portion of a body of a current transformer of the current transformer assembly.

In a further example embodiment, the center opening is rectangular.

In a further example embodiment, the center opening is larger than the first and second openings of the first plurality of openings and the first and second openings of the second plurality of openings.

In a further example embodiment, the center opening is aligned with the first and second openings of the first plurality of openings and the first and second openings of the second plurality of openings.

In a further example embodiment, the first section has a first width, the second section has a second width, and the third section has a third width. The first, second and third widths extend transversely to the longitudinal axis.

In a further example embodiment, the third width is larger than the first and second widths.

In a further example embodiment, the first width and the second width are the same.

In an example embodiment, the first plurality of openings and the second plurality of openings are positioned to replicate openings in a current transformer.

An example kit is disclosed. The kit comprises a plurality of template devices. Each device of the plurality of devices comprises a plate having a first section, a second section, a third section, and first and second ends oppositely disposed. The first section includes the first end. The second section includes the second end. The third section is positioned between the first and second sections. Each device of the plurality of devices comprises a pattern of openings that corresponds to positioning of bolt holes within a bar of a bar-type current transformer assembly. The pattern of openings comprises a first plurality of openings positioned in the first section and configured to overlie holes defined within a first portion of the bar of the current transformer assembly. The pattern of openings comprises a second plurality of openings positioned in the second section and configured to overlie holes defined within a second portion of the bar of the current transformer assembly.

In an example embodiment, each device corresponds to a current transformer having a rating.

In a further example embodiment, the corresponding rating of the current transformer is different for each device.

In an example embodiment, the pattern of openings for each device of the plurality of devices corresponds to a different bar-type current transformer assembly.

An example method is disclosed. The method comprises forming a device as described herein. The device is formed by a three-dimensional (3D) printing process.

An example method of using a device as described herein for confirming a bolt pattern of a current transformer cabinet is disclosed. The method comprises positioning the device where a current transformer is to be installed in the current transformer cabinet, and confirming whether the bolt pattern is correct.

### BRIEF DESCRIPTION OF DRAWINGS

FIG. 1 is a photograph of an example current transformer cabinet and current transformer assembly according to the prior art;

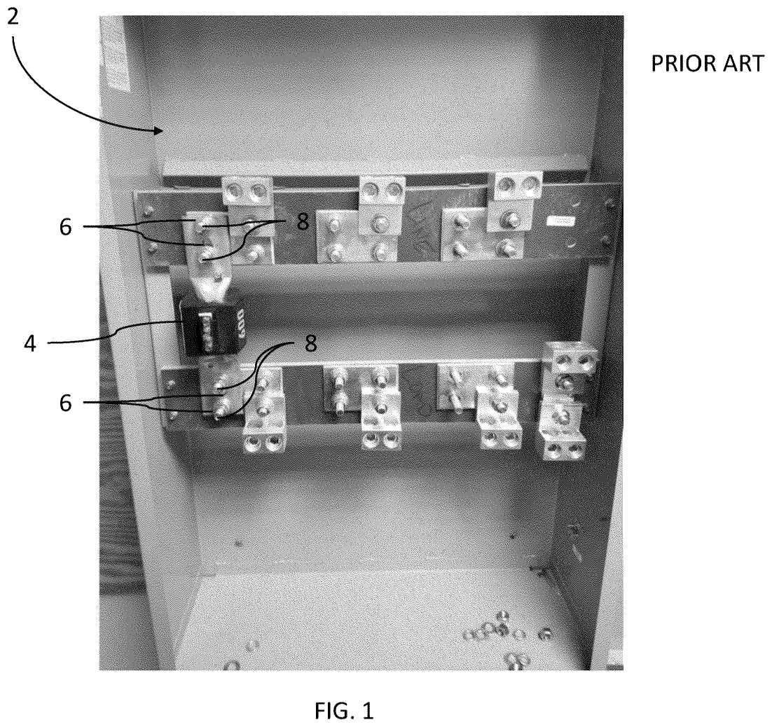

FIG. 2 is a photograph of an example template device according to the disclosure;

FIG. 3 is a photograph of the example template device of FIG. 1 and an example corresponding current transformer; and

FIG. 4 is a photograph of an example kit according to the disclosure.

### DETAILED DESCRIPTION

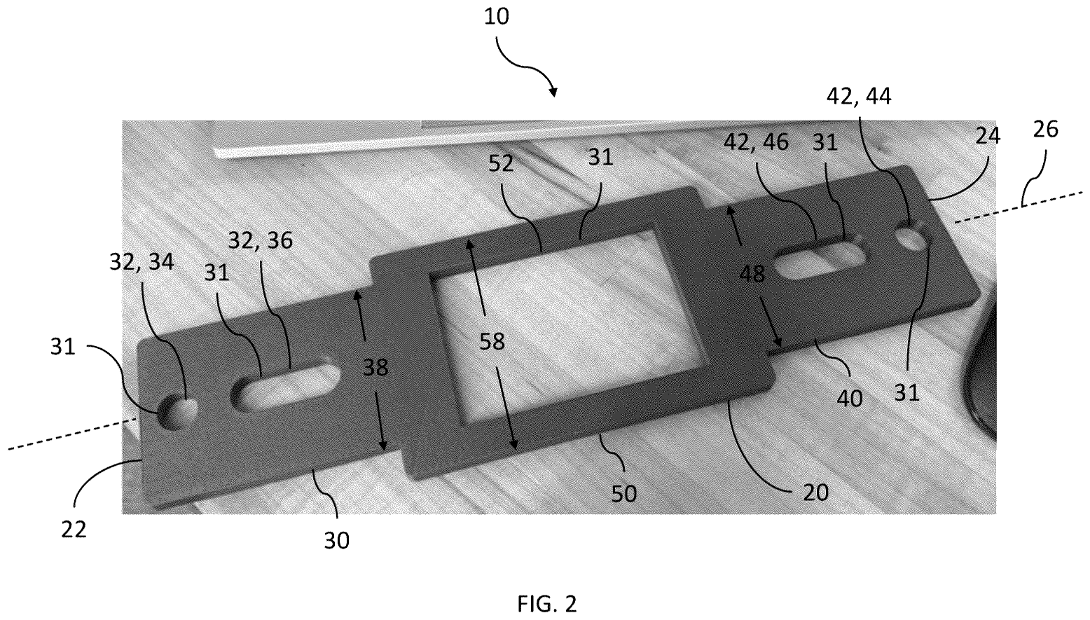

FIG. 2 shows an example template device 10 according to the disclosure. Optionally, the device 10 may be used to confirm a pattern of fixed bolts in a current transformer cabinet is installed correctly. The device 10 may weigh 0.1-1.0 pound. Optionally, the device 10 may weigh 0.2-0.4 pound. The template device 10 comprises a plate 20 extending along a longitudinal axis 26 having first and second ends 22, 24 oppositely disposed. The plate 20 may consist of non-conductive or non-metallic material so that the template device 10 will not cause a flash if the template device 10 contacts an energized conductor. Optionally, the plate 20 may consist of a plastic material. Advantageously, corners and/or edges of the plate 20 may be rounded to prevent injury, for example puncture wounds, to the user. The plate has a first section 30, a second section 40, and a third section 50. The first section 30 includes the first end 22. The second section 40 includes the second end 24. The third section 50 is positioned between the first and second sections 30, 40. As shown in FIG. 2, the first section 30 has a first width 38, the second section 40 has a second width 48, and the third section 50 has a third width 58. The first, second and third widths 38, 48, 58 extend transversely to the longitudinal axis 26. Optionally, the third width 58 is larger than the first and second widths 38, 48. The first width 38 and the second width 48 may be the same.

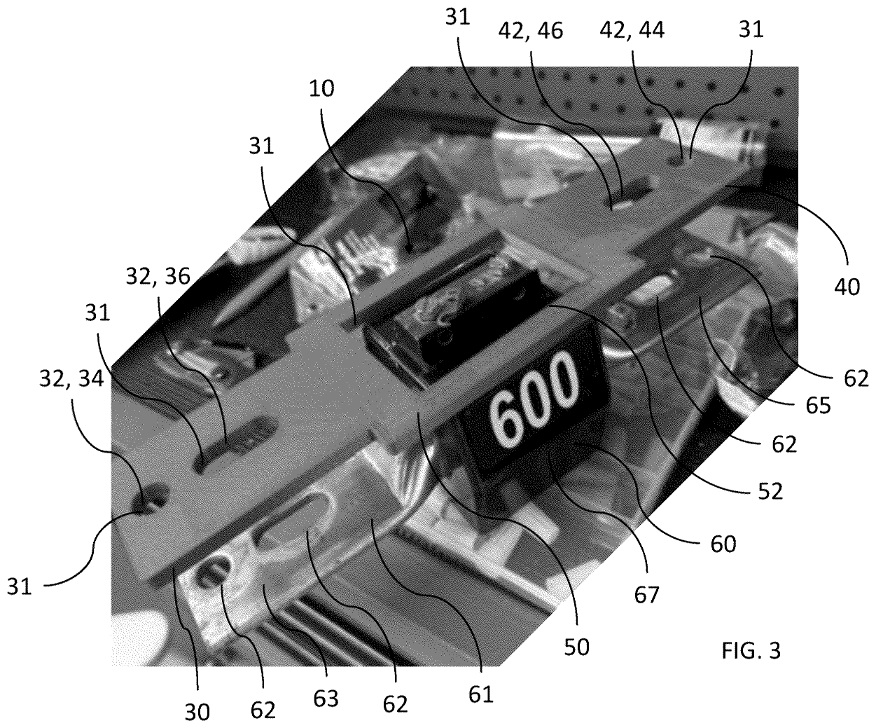

As shown in FIG. 3, the template device 10 comprises a pattern of openings 31 that corresponds to positioning of bolt holes 62 within a bar 61 of a bar-type current transformer assembly 60. The pattern of openings 31 comprises a first plurality of openings 32 positioned in the first section 30 and a second plurality of openings 42 positioned in the second section 40. The first plurality of openings 32 and the second plurality of openings 42 are configured to overlie holes 62 defined in the bar 61 of the current transformer assembly 60. The first plurality of openings 32 are configured to overlie holes 62 defined within a first portion 63 of the bar 61 of the current transformer assembly 60. The second plurality of openings 32 are configured to overlie holes 62 defined within a second portion 65 of the bar 61 of the current transformer assembly 60. As shown in FIG. 3, the first plurality of openings 32 and the second plurality of openings 42 are positioned to replicate openings 62 in the current transformer assembly 60.

As shown in FIGS. 2 and 3, the first plurality of openings 32 may comprise a first opening 34 and a second opening 36. The first opening 34 of the first plurality of openings 32 and the second opening 36 of the first plurality of openings 32 may be aligned along the longitudinal axis 26. The second opening 36 of the first plurality of openings 32 may be positioned between the first opening 34 of the first plurality of openings 32 and the third section 50. The first opening 34 of the first plurality of openings 32 may be circular. The second opening 36 of the first plurality of openings 32 may be elongated.

The second plurality of openings 42 may comprise a first opening 44 and a second opening 46. The first opening 44 of the second plurality of openings 42 and the second opening 46 of the second plurality of openings 42 may be aligned along the longitudinal axis 26. The second opening 46 of the second plurality of openings 42 may be positioned between the first opening 44 of the second plurality of openings 42 and the third section 50. The first opening 44 of the second plurality of openings 42 may be circular. The second opening 46 of the second plurality of openings 42 may be elongated.

Although the first plurality of openings 32 and second plurality of openings 42 are each shown comprising a first circular opening and a second elongated opening in FIGS. 2 and 3, it is contemplated that the first plurality of openings and the second plurality of openings may comprise other quantities, shapes, and/or positions of openings. For example, the first plurality of openings 32 and second plurality of openings 42 may comprise four circular openings evenly spaced apart.

As shown in FIGS. 2 and 3, the pattern of openings 31 may comprise a center opening 52 positioned in the third section 50 to reduce the mass and weight of the device 10 thereby making it easier to carry and handle. Optionally, the center opening 52 may provide a location for a carrying mechanism such a hook, clip or carabiner. As shown in FIG. 3, the center opening 52 may be configured to overlie at least a portion of a current transformer body 67 of the current transformer assembly 60. The center opening 52 may be rectangular. The center opening 52 may be larger than the first and second openings 34, 36 of the first plurality of openings 32 and the first and second openings 44, 46 of the second plurality of openings 42. The center opening 52 may be aligned with the first and second openings 34, 36 of the first plurality of openings 32 and the first and second openings 44, 46 of the second plurality of openings 42.

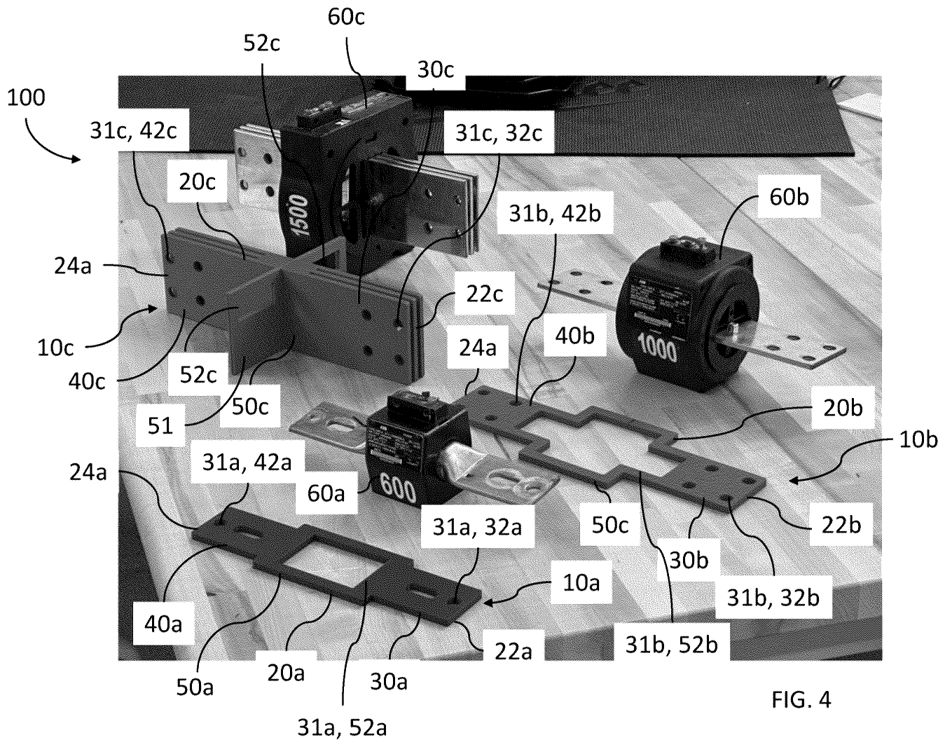

FIG. 4 shows an example kit 100 according to the invention. The kit comprises a plurality of template devices 10a, 10b, 10c. Each template device 10a, 10b, 10c of the kit 100 may include details and embodiments according to the template device 10 disclosed herein. As shown in FIG. 4, each device 10a, 10b, 10c of the kit 100 comprises at least one plate 20a, 20b, 20c having first and second ends 22a, 22b, 22c, 24a, 24b, 24c oppositely disposed. Each plate 20a, 20b, 20c has a first section 30a, 30b, 30c, a second section 40a, 40b, 40c, and a third section 50a, 50b, 50c. The first section 30a, 30b, 30c includes the first end 22a, 22b, 22c. The second section 40a, 40b, 40c includes the second end 24a, 24b, 24c. The third section 50a, 50b, 50c is positioned between the first and second sections 30a, 30b, 30c, 40a, 40b, 40c.

Each device 10a, 10b, 10c comprises a pattern of openings 31a, 31b, 31c that corresponds to positioning of bolt holes within a bar of a bar-type current transformer assembly. The pattern of openings 31a, 31b, 31c for each device 10a, 10b, 10c of the kit 100 may correspond to bolt holes within a different bar-type current transformer assembly 60a, 60b, 60c. For example, each device 10a, 10b, 10c of the kit 100 may correspond to a current transformer assembly having a rating wherein the corresponding rating of the current transformer assembly may be different for each device 10a, 10b, 10c. For example, a first device 10a may correspond to a current transformer assembly 60a having a rating of 600, a second device 10b may correspond to a current transformer assembly 60b having a rating of 1000, and a third device 10c may correspond to a current transformer assembly 60c having a rating of 1500. The bar-type current transformer assembly of a specific rating may have a unique bolt-hole pattern than bar-type current transformer assemblies having a different rating thereby requiring different device templates 10a, 10b, 10c with different patterns of openings 31a, 31b, 31c.

Each pattern of openings 31a, 31b, 31c may comprise a first plurality of openings 32a, 32b, 32c positioned in the first section 30a, 30b, 30c and a second plurality of openings 42a, 42b, 42c positioned in the second section 40a, 40b, 40c. The first plurality of openings 32a, 32b, 32c is configured to overlie holes defined within a first portion of a bar of a current transformer assembly. The second plurality of openings 42a, 42b, 42c is configured to overlie holes defined within a second portion of the bar of the current transformer assembly.

The first plurality of openings 32a may comprise a first opening and a second opening. The second opening of the first plurality of openings 32a may be positioned between the first opening of the first plurality of openings 32a and the third section 50a. The first opening of the first plurality of openings 32a may be circular. The second opening of the first plurality of openings 32a may be elongated. Alternatively, the first plurality of openings 32b, 32c may comprise four circular openings spaced evenly apart.

The second plurality of openings 42a may comprise a first opening and a second opening. The second opening of the second plurality of openings 42a may be positioned between the first opening of the second plurality of openings 42a and the third section 50a. The first opening of the second plurality of openings 42a may be circular. The second opening of the second plurality of openings 42a may be elongated. Alternatively, the second plurality of openings 42b, 42c may comprise four circular openings spaced evenly apart.

As shown in FIG. 4, the pattern of openings 31a, 31b, 31c may comprise a center opening 52a, 52b, 52c. Optionally, the center opening 52a, 52b is positioned in the third section 50a, 50b. Optionally, the third section 50c includes a transverse plate 51 comprising the center opening 52c. The center opening 52a, 52b, 52c may be rectangular or cross shaped. The center opening 52a, 52b, 52c may be larger than other openings of the first plurality of openings 32a, 32b, 32c and the second plurality of openings 42a, 42b, 42c.

A method of manufacturing the device 10 is disclosed herein. The method may comprise forming the device via a three-dimensional (3D) printer.

A method of using the device 10 to confirm a pattern of fixed bolts in a current transformer cabinet is installed correctly is disclose herein. The method comprises:
positioning the device where a current transformer assembly is to be installed in the current transformer cabinet, and
confirming whether the bolt pattern is correct.

The bolt pattern may be confirmed to be correct when the pattern of openings 31 of the template device 10 align with the fixed bolts in the transformer cabinet. For example, the first plurality of openings 32 and the second plurality of openings 34 align with the fixed bolts in the transformer cabinet.

It is expected that the example template device 10 and kit 100 according to the invention will allow a technician to test fit equipment, such as fixed bolts in a current transformer cabinet, without carrying the current transformer assemblies to the current transformer cabinet thereby reducing strains and sprains on the technician as the technician will not have to carry a box of current transformer assemblies weighing about 20 pounds.

All of the embodiments of the claimed invention described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

What is claimed is:

1. A template device, the device comprising:
a plate having a first section, a second section, a third section, and first and second ends oppositely disposed, the first section including the first end, the second section including the second end, and the third section being positioned between the first and second sections;
a pattern of openings that corresponds to positioning of bolt holes within a bar of a bar-type current transformer assembly, the pattern of openings comprising:
a first plurality of openings positioned in the first section and configured to overlie holes defined within a first portion of the bar of the current transformer assembly; and
a second plurality of openings positioned in the second section and configured to overlie holes defined within a second portion of the bar of the current transformer assembly.

2. The device according to claim 1, wherein the plate consists of a non-conductive material.

3. The device according to claim 1, wherein the plate extends along a longitudinal axis.

4. The device according to claim 3, wherein the first plurality of openings comprises a first opening and a second opening.

5. The device according to claim 4, wherein the second opening of the first plurality of openings is positioned between the first opening of the first plurality of openings and the third section.

6. The device according to claim 4, wherein the first opening of the first plurality of openings is circular.

7. The device according to claim 6, wherein the second opening of the first plurality of openings is elongated.

8. The device according to claim 4, wherein the first opening of the first plurality of openings and the second opening of the first plurality of openings are aligned along the longitudinal axis.

9. The device according to claim 8, wherein the second plurality of openings comprises a first opening and a second opening.

10. The device according to claim 9, wherein the second opening of the second plurality of openings is positioned between the first opening of the second plurality of openings and the third section.

11. The device according to claim 9, wherein the first opening of the second plurality of openings is circular.

12. The device according to claim 11, wherein the second opening of the second plurality of openings is elongated.

13. The device according to claim 9, wherein the first opening of the second plurality of openings and the second opening of the second plurality of openings are aligned along the longitudinal axis.

14. The device according to claim 13, wherein the pattern of openings further comprises a center opening positioned in the third section, the center opening is configured to overlie a portion of a body of a current transformer of the current transformer assembly.

15. The device according to claim 1, wherein the first plurality of openings and the second plurality of openings are positioned to replicate openings in a current transformer.

16. A kit comprising:
a plurality of template devices, each device of the plurality of devices comprising:
a plate having a first section, a second section, a third section, and first and second ends oppositely disposed, the first section including the first end, the second section including the second end, and the third section being positioned between the first and second sections; and
a pattern of openings that corresponds to positioning of bolt holes within a bar of a bar-type current transformer assembly, the pattern of openings comprising:
a first plurality of openings positioned in the first section and configured to overlie holes defined within a first portion of the bar of the current transformer assembly; and
a second plurality of openings positioned in the second section and configured to overlie holes defined within a second portion of the bar of the current transformer assembly
17. The kit according to claim 16, wherein each device corresponds to a current transformer having a rating, wherein the corresponding rating of the current transformer is different for each device.

18. The kit according to claim 16, wherein the pattern of openings for each device of the plurality of devices corresponds to a different bar-type current transformer assembly.

19. A method comprising:
forming a device according to claim 1,
wherein the device is formed by a three-dimensional (3D) printing process.

20. A method of using a device according to claim 1 for confirming a bolt pattern of a current transformer cabinet, the method comprising:
positioning the device where a current transformer is to be installed in the current transformer cabinet, and
confirming whether the bolt pattern is correct.
